(19) United States
(12) Patent Application Publication
(10) Pub. No.: US 2008/0056807 A1
(43) Pub. Date: Mar. 6, 2008

(54) Dispenser/Applicator/Proportioner For A Cosmetic Product

(76) Inventor: Anne-Sophie Vintimiglia, Paris (FR)

Correspondence Address: BANNER & WITCOFF, LTD., TEN SOUTH WACKER DRIVE, SUITE 3000, CHICAGO, IL, 60606, US

(21) Appl. No.: 11/839,877

(22) Filed: Aug. 16, 2007

(30) Foreign Application Priority Data
Sep. 5, 2006 (FR) 06 07752

(51) Int. Cl. A46B 11/00; A47L 13/22; B43K 5/06

(52) U.S. Cl. 401/277; 132/218; 401/172

(57) ABSTRACT

The dispenser applicator (1) for a cosmetic product has an axial direction (10) and includes:
a) an axial body (2) including a reservoir (20), an application means (3),a means of transfer (4) of said cosmetic product from said reservoir (20) to said application means (3),
b) a cap (5) including a wiping means (50) of said application means (3).

Said body (2) includes a lower portion (6) forming at least one portion of said reservoir, and an upper portion (7) cooperating in rotation and delimiting said reservoir (20), said upper portion (7) being solidly connected to said application means (3) and equipped with an upper opening (70) making a passage of said product possible from said reservoir (20) to said application means (3).

Said means of transfer (4) includes a threaded piston (40) mobile axially in said reservoir (20), and a central rod (41) solidly connected in rotation to said upper portion (7), said piston (40) cooperating with said central rod (41) and with said lower portion (6) in such a way that a rotation of said upper portion (7) in relation to said lower portion (6) causes an axial movement of said piston (40) and a transfer of a fraction of said cosmetic product to said application means (3).

### FIELD OF THE INVENTION

This invention relates to the field of dispenser/applicators for cosmetic products, typically cosmetic products for eye make-up, such as mascaras for example, which are viscous products.

### PRIOR ART

A large number of dispenser/applicators for mascara are already known.

They typically include applicators, intended to cooperate with a recipient forming a reservoir for the mascara.

These applicators typically include:

a) a cap intended to seal said recipient and to serve as a means for gripping said applicator,

b) an axial rod,

c) and an application means typically comprised of a brush,

said rod being solidly connected to said cap at one of its ends, and to said brush at the other of its ends,

said brush including a metal twist solidly connecting a plurality of hairs.

With regards to said brush, many embodiments of brushes are already known.

Thus, brushes described in French patents FR 2 505 633, FR 2 605 505, FR 2 607 372, FR 2 607 373, FR 2 627 068, FR 2 627 363, FR 2 637 471, FR 2 637 472, FR 2 650 162, FR 2 663 826, FR 2 668 905, FR 2 675 355, FR 2 685 859, FR 2 690 318, FR 2 701 198, FR 2 706 749, FR 2 715 038, FR 2 745 481, FR 2 748 913, FR 2 749 489, FR 2 749 490, FR 2 753 614, FR 2 755 593, FR 2 774 269, FR 2 796 531, FR 2 796 532, FR 2 800 586 are known.

Brushes described in U.S. Pat. No. 4,733,425, U.S. Pat. No. 4,861,179, U.S. Pat. No. 5,357,987, U.S. Pat. No. 5,595,198, U.S. Pat. No. 6,241,411, U.S. Pat. No. 6,427,700 are also known.

Mascara applicators are also known including, as an application means, a part moulded from plastic material, as described for example in French patent FR 2 868 264 filed by the applicant.

A dispenser/applicator is also known as described in European patent EP 0 553 021 wherein the brush is solidly connected to a hollow rod in communication with a reservoir.

### PROBLEMS WITH PRIOR ART

Prior art dispensers/applicators have a certain number of problems.

On one hand, they can have difficulty in being used with developments in mascara formulas which include volatile constituents, with dispenser applicators having to present an improved seal for this reason, which can be difficult to obtain in the case of traditional dispenser applicators.

On the other hand, they generally include a reservoir whose contents are placed into contact with the air and ambient atmosphere each time they are used. This can in particular result in progressive drying of the product contained in the reservoir.

In addition, the restitution rate of the product is generally not very high taking into account the fact that, in traditional applicator dispensers, the product goes back up into the reservoir, at each wiping, since the product being wiped is generally not fluid enough to flow back down to the bottom and rejoin the mass of the remaining product, such that a relatively large quantity of mascara adheres to the upper portion of the reservoir without being accessible to the brush.

In addition, the effects of make-up can vary according to the application means: those obtained with a traditional brush are not identical to those obtained in the case where a moulded part forms said applications means.

Finally, it may be advantageous to withdraw from the reservoir, at each application, only a predetermined quantity and typically a quantity that is just enough to limit excess product to remove thanks to the wiper element, in such a way that almost all of the product extracted from said reservoir is found on the application means after passing through the wiper element, the wiper element therefore serving more to ensure homogenous distribution of the product on the applications means than to remove a large amount of excess product from said application means.

### DESCRIPTION OF THE INVENTION

According to the invention, the dispenser applicator for a cosmetic product presents an axial direction and includes:

a) an axial body including:

a1) a reservoir forming a cavity that is able to contain said cosmetic product,

a2) an applications means of said cosmetic product,

a3) a means of transferring said cosmetic product from said reservoir to said application means,

b) a cap cooperating with said body when said dispenser is closed, said cap including a wiping means said application means, in such a way that said application means are wiped each time that said cap is separated from said body.

This dispenser applicator is characterised in that:

1) said body includes a lower part forming at least one portion of said reservoir, and an upper portion cooperating in rotation and delimiting said reservoir, said upper portion being solidly connected to said applications means and equipped with an upper opening making it possible to pass said product from said reservoir to said application means,

2) said means of transfer includes:

2a) a threaded piston mobile axially in said reservoir,

2b) a central rod solidly connected in rotation to said upper portion, said central rod extending axially through said reservoir, said piston cooperating with said central rod and with said lower portion in such a way that a relative rotation of said upper portion in relation to said lower portion forms a manual operation of said means of transfer by causing an axial movement of said piston and thus a transfer of a fraction of said cosmetic product to said application means.

The dispenser applicator solves the problems of prior art, as it will appear in particular using the figures.

Indeed, this dispenser applicator makes it possible, at each use, to extract from said reservoir and to transfer only the quantity of mascara necessary for one application, in such a way that:

only the fraction of the mascara exiting the reservoir is in contact with the ambient air,

only this fraction is transferred to the application means, with no risk of losing or accumulating mascara.

In addition, it makes it possible to obtain a high degree of sealing as well as to use an application means that differs from traditional brushes.

### DESCRIPTION OF THE FIGURES

All of the figures concern the invention.

FIGS. 1a to 2c are axial profile views of a same dispenser method (1). In FIGS. 1a to 2c, the cosmetic product in the application means (3) has been shown with hash marks, with mark (9).

FIG. 1a shows dispenser (1) closed, with cap (5) being snapped to body (2).

FIG. 1b shows dispenser (1) half-open in the process of being opened, body (2) being partially separated from cap (5), with cap (5) including a mobile tubular insert (53a) drawn into position by the applicator (30) of application means (3).

FIG. 2a shows dispenser (1) open, with body (2) being totally separated from cap (5).

FIG. 2b shows dispenser in the process of closing, with the upper end of applicator (30) starting to enter into the wiping lip (560) of wiper element (56) solidly connected to the mobile insert (53a) of cap (5).

FIG. 2c shows the dispenser half-open, in a manner analogous to FIG. 1b, but in the process of being closed.

FIGS. 3a to 4b concern another dispenser method (1) including a means of rotation through axial movement (12) wherein the axial movement of cap (5) in relation to the body (2) causes the upper portion (7) to rotate automatically in relation to the lower portion (6) and in this way the automatic transfer of a fraction of said cosmetic product to said application means (3).

FIG. 3a shows dispenser (1) at the start of opening, the cap (5) no longer cooperating with body (2) by snapping following an axial shift of 3 mm.

FIG. 3b shows on the left-hand side of the figure the left-hand side of the body (2) as seen from the side, and on the right-hand side of the figure, a right axial section of the closed dispenser (1).

FIG. 3c is an enlargement of the portion of FIG. 3b bordered with a rectangle.

FIG. 4a is an axial profile view of closed dispenser (1).

FIGS. 4b and 4c are enlargements of the portions of FIG. 4a bordered by a rectangle marked “b” for FIG. 4b and “c” for FIG. 4c.

FIGS. 5a to 5c show an axial profile view of the filling of a dispenser (1) corresponding to another dispenser method (1) analogous to that in FIGS. 1a to 2c, but which is distinguished from them in particular by the method of assembly of the lower (6) and upper (7) portions.

FIG. 5a is a partial view of closed dispenser (1) obtained after filling—with the cosmetic product itself not being shown for reasons of simplifying the figure.

FIG. 5b is a partial view of a subset including cap (5), the portion of the body (2) including the application means (3) and the upper portion (7).

FIG. 5c is a view of the lower portion (6) of the body (2) forming the substantial portion of the reservoir (20), in such a way that, once this lower portion (6) is loaded with cosmetic product, the subset in FIG. 5b is snapped in.

FIGS. 6a to 7b schematically show an operating method of the means of rotation by axial movement (12) of dispenser (1), axial body (2) being shown in a partial side view, cap (5) being shown, in the form of hashed crossed lines, as a partial axial profile section, by a left portion of its skirt (55) and by elements (55, 121, 125) relative to means of rotation by axial movement (12) placed on the interior of said skirt (55).

FIG. 6a shows dispenser (1) before complete closing, with radial projections (121) being still positioned above the helix portions (120).

FIG. 6b shows closed dispenser (1), with radial projections (121) being positioned below the helix portions (120).

FIG. 7a shows dispenser (1) when it is opened again, radial projections (121) cooperating with the portions of helix (120) in such a way as to cause the relative rotation of the upper portion (7) in relation to lower portion (6).

FIG. 7b shows cap (5) of FIGS. 6a to 7a.

FIGS. 8a and 8b are partial left axial half-sections of another body method (2) wherein said means of transfer (4) includes the cooperation of a threaded solid central rod (41a), said piston (40) being a “low” piston.

FIG. 8a shows body (2) after loading of the product into reservoir (20).

FIG. 8b shows the subset formed by the lower portion (6), piston (40b) and solid central rod (41a) intended to be filled with a cosmetic product.

FIGS. 9a to 9c concern a dispenser method (1) wherein the means of rotation (11) is a means of rotation through relative rotation (13) including in particular the cooperation of axial ribs and grooves (130, 131) which makes rotation possible of said upper portion (7) through manual rotation of cap (5) with the dispenser (1) being closed.

FIG. 9a is a partial axial profile view of dispenser (1) closed that shows said means through relative rotation (13).

FIG. 9b is a view of the section according to transversal plane B-B of FIG. 9a, of the cooperation of male and female parts (132, 133) forming an angular indicator of rotation—example provided at 4 positions directed at 90° each in relation to the following one.

FIG. 9c is a view of a partial section according to transversal plane C-C of FIG. 9a that shows the cooperation of axial ribs and grooves (130, 131).

### DETAILED DESCRIPTION OF THE INVENTION

According to the invention, said application means (3) can include an applicator (30) and a hollow axial rod (31) forming a channel (310) emerging on said upper opening (70) and thereby in communication with said reservoir (20), in such a way that said relative rotation causes a transfer of said product to said applicator (30).

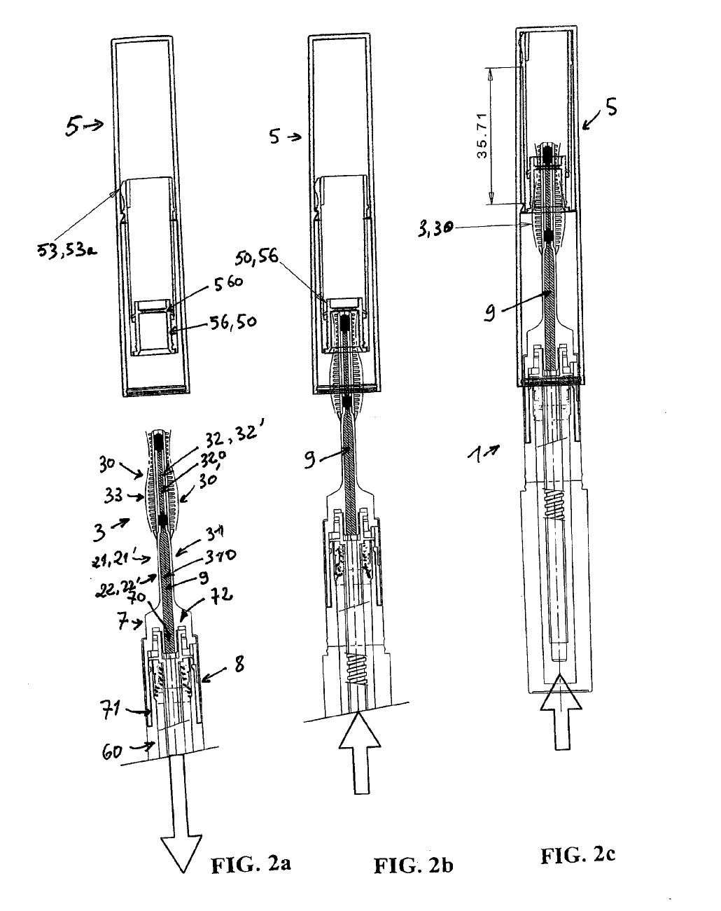

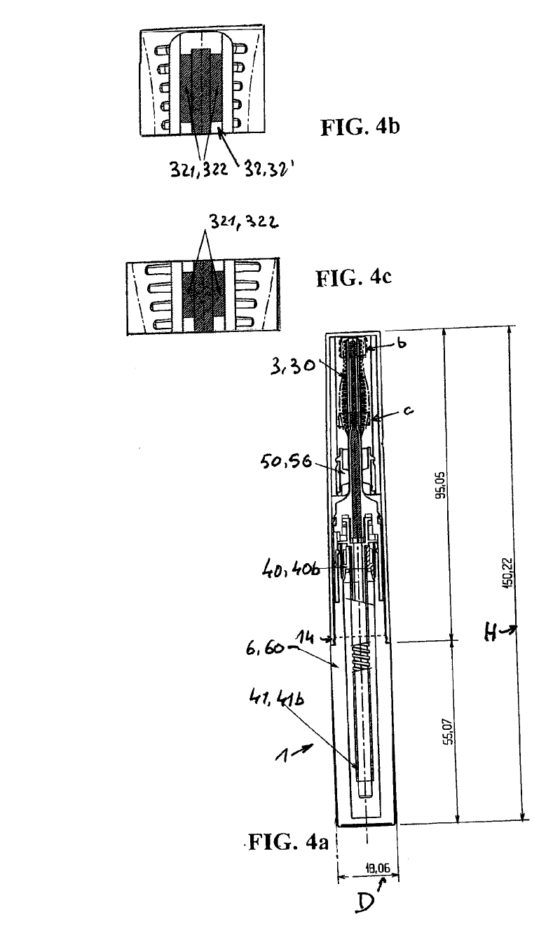

As shown in FIGS. 2a, and 4a to 4c, said applicator (30) can include a central core (32) and an application material (33), said central core (32) being a hollow central core (32′) equipped with a central duct (320) in communication with said channel (310) of said hollow axial rod (31), said hollow central core (31) including at least one distribution zone of said product (321) thanks to at least one typically lateral opening (322), in such a way that said relative rotation causes a direct transfer of said product onto said application material (33).

Said applicator (30) can form a moulded part of plastic material (30′).

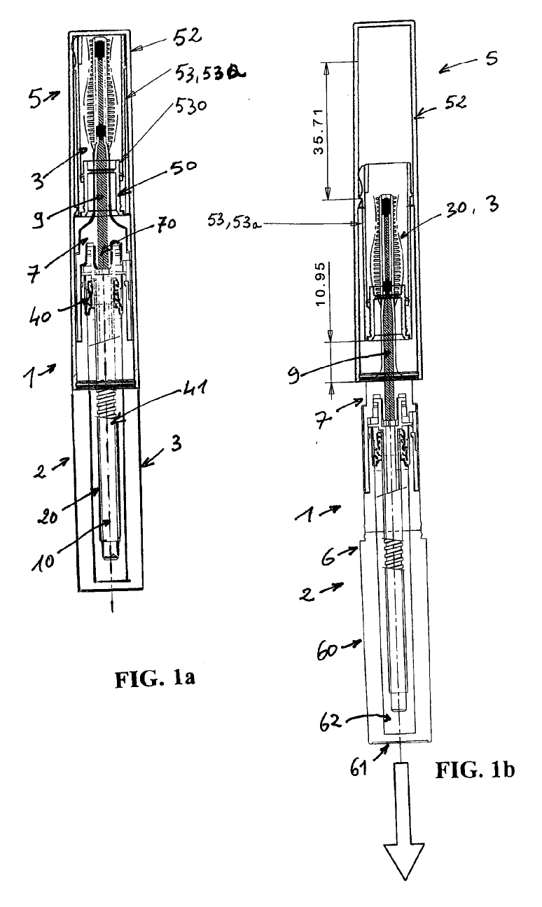

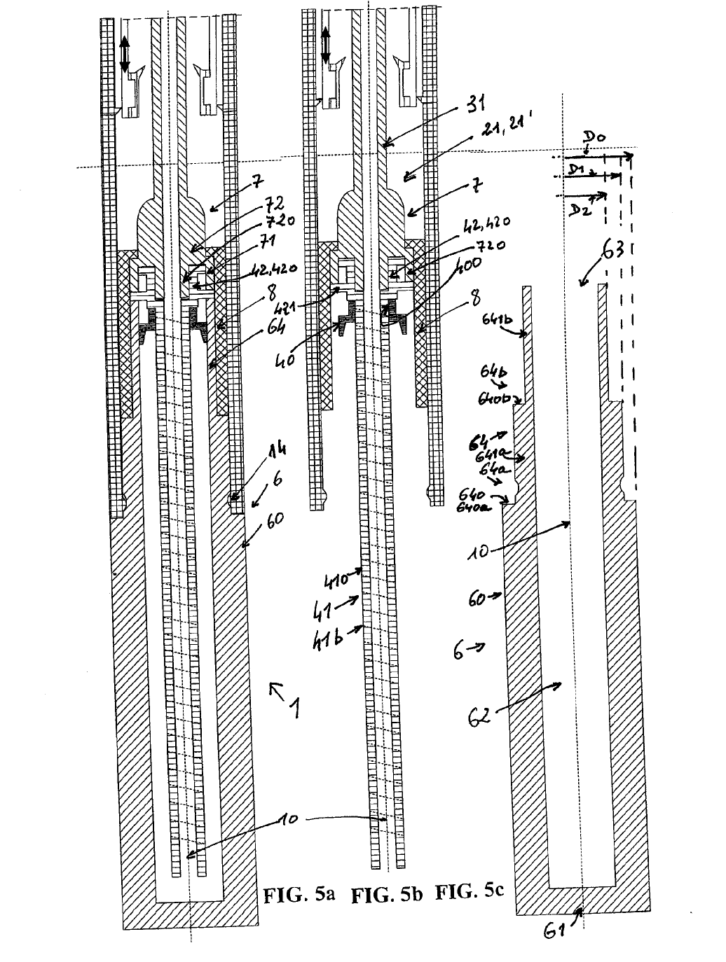

As shown for example in FIGS. 1b and 5c, said lower portion (6) can include one lower skirt (60) and a bottom (61) in such a way as to form a lower cavity (62) of said reservoir, said lower skirt (60) having an upper opening (63) at its upper end, in such a way as to be able to fill said lower cavity (62) with said product, said upper portion (7) forming a means of sealing said upper opening (63).

As shown in FIG. 2a, said upper portion (7) can include a transversal portion (72) including said upper opening (70) and solidly connected to said hollow axial rod (31), said transversal portion (72) cooperating in rotation with said central rod (41) and forming said means of sealing of said upper opening (63), said upper portion (7) cooperating axially with said lower portion (6) typically through axial cooperation of an upper skirt (71) of said upper portion (7) with said lower portion (6), or possibly using a band (8) solidly connecting said upper portion (7) axially to said lower portion (6).

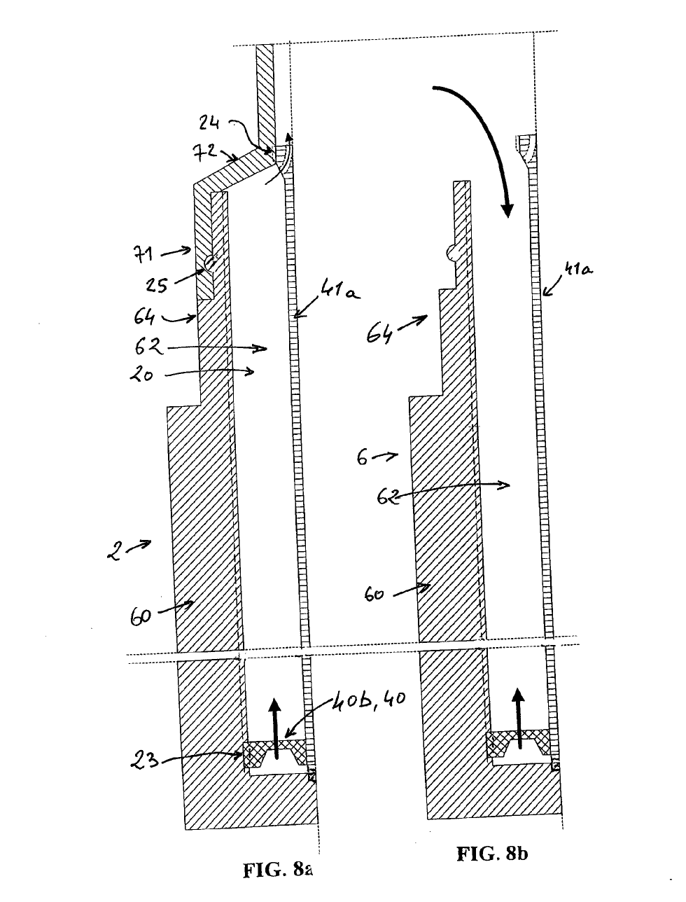

As shown in FIG. 8a, upper portion (7) and lower portion (6) can be solidly connected axially through the means of axial snapping (25) through cooperation of a circular groove forming a hollow element with a circular rib forming a raised element.

As shown in particular in FIG. 5c, said lower skirt (60) can include an upper portion (64) tiered exteriorly including at least one tier equipped with a shoulder (640) and a thinned axial portion (641), said tiered upper portion (64) cooperating at least with said upper skirt (71) of said upper portion (7).

Said tiered upper portion (64) can include two tiers, one said first tier (64a) with a said first shoulder (640a) corresponding typically to a reduction in the exterior diameter from D₀ to D₁, and a said first thinned axial portion (641a), and one said second tier (64b) with a said second shoulder (640b) corresponding typically to reduction in exterior diameter from D₁ to D₂, and a said second thinned axial portion (641b), said first tier (64a) being able to cooperate with a lower end (51) of said cap (5) of exterior diameter typically equal to D₀, and said second tier (64b) being able to cooperate with said upper skirt (71) of said upper portion (7) of exterior diameter typically equal to D1.

According to the invention, and as shown for example in FIGS. 2a and 5a, said upper (6) and lower (7) portions can cooperate through axial snapping, typically irreversible, possibly thanks to a typically metal band (8) forming a ring reinforcing the solidity of the cooperation between said upper and lower portions, while still making relative rotation possible of said upper (6) and lower (7) portions in relation to one another.

As shown in FIGS. 5a and 5b in particular, said threaded piston (40) can include central threading (400) cooperating with a corresponding threading (410) of said central rod (41), said piston (40) being solidly connected in rotation to said lower portion (6), typically through cooperation of axial ribs and grooves, or through an interior non-circular section of said lower skirt.

According to an inverse method, not shown in a figure, said threaded piston (40) can include a peripheral threading cooperating with a corresponding threading carried by an interior surface of said lower portion (6), typically of said lower skirt (60), said piston (40) being solidly connected in rotation with said central rod (41), typically thanks to a non-circular section.

According to a method of the invention, and as shown in FIGS. 8a and 8b, said central rod (41) can be a solid central rod (41a), and said piston (40) can be a low piston (40a) able to move axially to said upper portion (7) during said relative rotation, in such a way as to propel said product, via said upper opening (70) to said application means (3) or onto said application material (33).

In this case, filling of dispenser (1) is done as drawn in FIG. 8b.

According to another method of the invention, and as shown in la to 5c, said central rod (41) can be a hollow central rod (41b) including an axial duct (411) over typically all its height, and said piston (40) can be a high piston (40b) able to move away axially from said upper portion (7) to said bottom (61) during said relative rotation, so as to ensure said direct transfer of said product onto said application material (33), said duct (411) of said hollow central rod (41b) emerging onto the channel (310) of the hollow axial rod (31) of application means (3).

In this case, filling of dispenser (1) is done as drawn in FIGS. 5a to 5c.

As shown in FIGS. 5a and 5b, said hollow central rod (41b) can include at its upper end (42), a female tubular portion (420) cooperating typically with a male tubular portion (720) of said transversal portion (72) of said upper portion (7), said male tubular portion (720) surrounding said upper opening (70), in such a way as to join said hollow central rod (41b) to said male tubular portion (720), and thereby place said hollow central rod (41b) into communication with said hollow axial rod (31) of said application means (3).

Said hollow central rod (41b) can include at least one radial crown (421, 421′) at its upper end (42), said radial crown ensuring a tight closing of said reservoir (20) and/or a centring of said hollow central rod (41b).

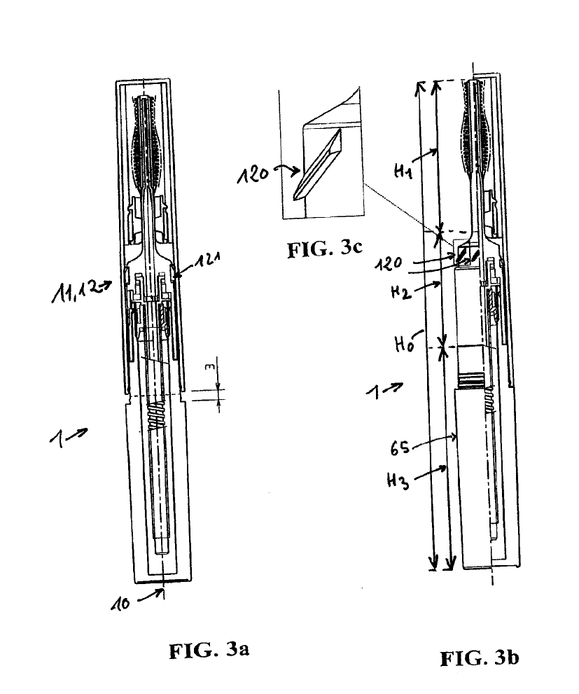

According to the invention, and as shown in FIG. 3b, said axial body (2) can have an axial height Ho ranging typically from 60 mm to 160 mm, said application means (3) having an axial height H₁ ranging from 20 mm to 60 mm, said upper portion (7) having an axial height H2 and said lower portion (6) including an exterior gripping portion (65) of axial height H₃, with H₀ equal to the sum of H₁+H₂+H₃, with H₂/H₃ ranging typically from 0.5 to 1.

Advantageously, and as shown for example in FIG. 5b, said upper portion (7) and said hollow axial rod (31) of said application means (3) can form a first one-piece part (21), typically a said first moulded part of plastic material (21′).

In addition, as shown in FIG. 2a in particular, said upper portion (7) and said application means (3) can form a second one-piece part (22), typically a second said moulded part of thermoplastic material (22′). In this case, said applicator (30), said hollow axial rod (31) and said upper portion (7) form a moulded one-piece part.

More preferably, said upper (7) and lower (6) portions can cooperate with a means of anti-rotation, in such a way as to make only one direction of relative rotation possible of said upper part (7) in relation to said lower part (6), and to ensure axial movement of said piston (40, 40a, 40b) only in the direction corresponding to the transfer of said product from said reservoir (20) to said application means (3), thus preventing any air from entering said reservoir (20).

According to the invention, said cap (5) can cooperate with said upper portion (7) in such a way as to form a means of rotation (11) of said upper portion (7) in relation to said lower portion (6) of a predetermined angle, a manual movement of said cap (5) in relation to said lower portion (6) thus causing a relative rotation of said predetermined angle of said upper portion (7) in relation to said lower portion (6).

As shown in FIGS. 3a to 3c, said means of rotation (11) can be a means of rotation (12) including a cooperation typically between a plurality of helix portions (120) and at least one radial projection (121), said plurality of helixes (120) and said radial projection (121) being, for example, carried respectively on the exterior surface of said upper skirt (71) and on the interior surface of an skirt (55) of said cap (5), said manual movement being an axial movement over an axial distance d, typically less than 10 mm, said axial movement of said cap (5) in relation to said lower part (7) on said distance d causing a relative rotation of said upper portion (7) in relation to said lower portion (6).

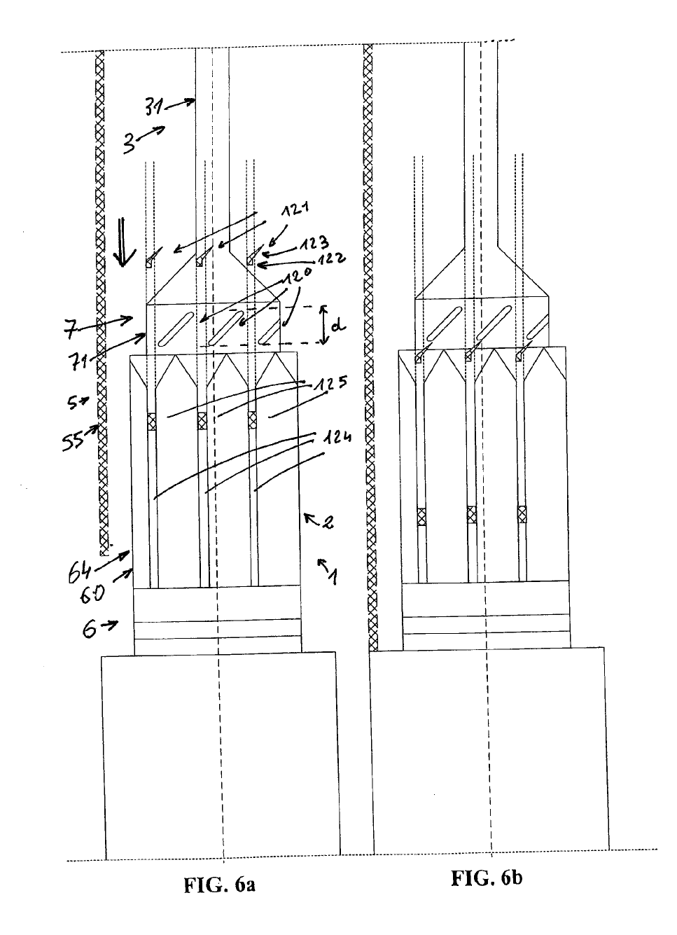

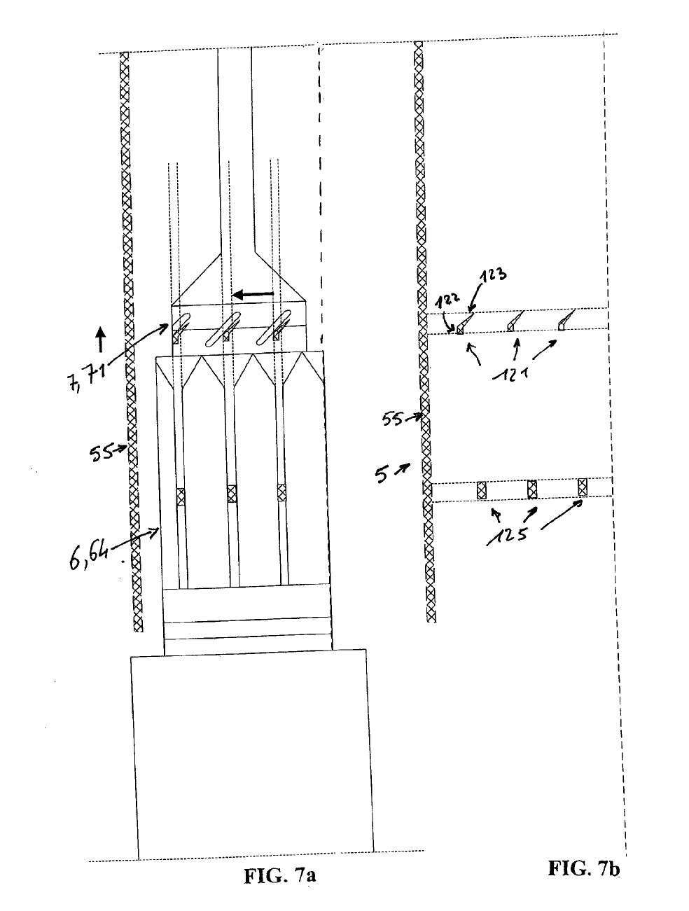

As shown in FIGS. 6a to 7b, said radial projection (121) can include a rigid lug (122) and a snap tongue (123) directed in such a way as to bend in contact with said portion of helix (120) during the closing of said dispenser (1), and to not bend during the opening of said dispenser, in such a way that the axial movement of said cap in relation to said body (2) causes the relative rotation of said upper portion (7) in relation to said lower portion (6) and therefore said transfer of a fraction of said cosmetic product to said application means (3).

In such a way as to automatically direct said radial projection (121) in relation to said plurality of portions of helix (120) during the re-closing of said dispenser (1), a plurality of axial grooves (124) and at least one radial stud (125) can cooperate, said plurality of axial grooves (124) and said radial stud (125) being, for example, carried respectively on the exterior surface of said lower skirt (60) and on the interior surface of an skirt (55) of said cap (5). See FIGS. 6a to 7b.

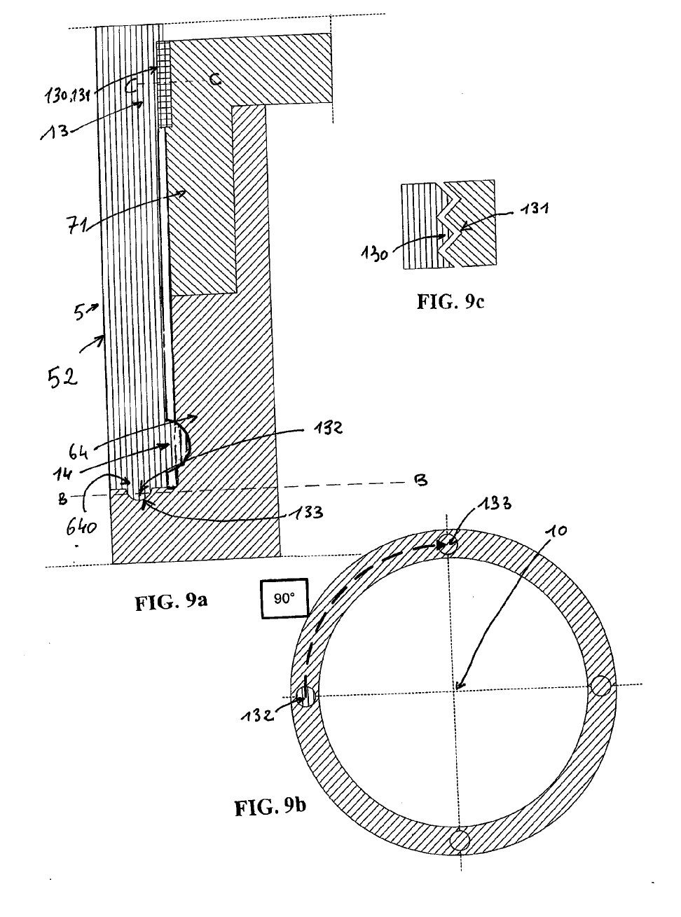

According to another method of the invention, and as shown in FIGS. 9a and 9c, said means of rotation (11) can be a means of rotation (13) including a cooperation typically between a plurality of axial ribs (130) and grooves (131) which cooperate when said dispenser is closed or almost closed, said manual movement being a relative rotation of said cap (5) in relation to said lower portion (6), said cap (5) and said upper portion (7) including a means of causing rotation typically formed by said plurality of ribs (130), formed on the interior surface of said cap (5) or on said upper skirt (71), cooperating with said plurality of axial grooves (131), formed respectively on said upper skirt (71) or on the interior surface of said cap (5), in such a way that the manual rotation of said cap (5) causes that of said upper portion (7), said dispenser being completely or partially closed.

As shown in FIGS. 9a and 9b, said cap (5) can cooperate with said lower portion (7) in such a way that said relative rotation has at least one given angular position whose crossing requires a manual effort that is greater than the standard effort of rotation, in such a way that said relative rotation extending over a predetermined angular range corresponding to a dose of said product, any user can automatically and easily transfer said dose of product to said application means (3).

As such, said shoulder (640) can include a plurality of typically hollow elements (133), regularly spaced—4 elements at 90° in the case of FIGS. 9a and 9b, and the lower end of the skirt of the cap can carry a raised element, so as to locate a relative rotation of 90°, said relative rotation making it possible to transfer a fraction of product to the applicator, with this fraction typically corresponding to one dose of product for one standard use.

According to the invention, and as shown in FIGS. 1a to 5b, said cap (5) can include an exterior shell (52) and an interior tubular insert (53) including said wiping means (50), typically a circular wiping lip (560) of wiper element (56) solidly connected to tubular insert (53).

AS shown in FIGS. 1a to 2c, said insert (53) can be an axially mobile insert (53a), able to slide in said shell (52) up to a bearing each time that said cap is separated from or assembled to said body, in such a way as to typically have a position referred to as “out” each time that said cap (5) is separated from said body (2), said insert (53) being thereby drawn by said application means (3) towards the exterior of said cap, taking into account the resistance offered by the wiping means (50) during the passage of said application means (3), and a position referred to as “in” each time that said cap (5) is assembled to said body (2), said wiping means (50) of said insert (53) being thereby drawn by said application means (3) towards the interior of said cap (5).

In said “out” position, said insert (53) can cooperate with said exterior shell (52) according to a means of reversible snapping (54), in order to make the introduction possible at least partially of said application means (3) in said wiping means (50) of said insert (53) each time that said cap (5) is assembled to said body (2), in such a way as to avoid any soiling of said shell (52) by said product, said insert (53) then passing from the “out” position to the “tin” position at the bottom of the shell (52).

The dispenser according to the invention can have an H/D form factor equal to at least 5, H being the height of said closed dispenser, and D corresponding to the greatest transversal dimension of said closed dispenser, typically at its diameter. As such, the dispenser in FIGS. 1a to 4a has a form factor greater than 8 (150.22 mm: 18.06 mm).

### EXAMPLES OF EMBODIMENTS

All of the figures comprise examples of embodiments.

### ADVANTAGES OF THE INVENTION

The dispenser according to the invention has many advantages:

on the one hand, it makes possible a very high rate of restitution of the product, in the neighbourhood of 100%, with almost all of the product initially contained in the body forming the reservoir being transferred to the applicator.

on the other hand, it makes it possible to maintain the cosmetic product with its original properties for a very long time, since the cosmetic product contained in the sealed reservoir is never in contact with atmospheric air, with the volume of the reservoir decreasing as the cosmetic product is consumed, in such a way that there cannot be any risk of modification of the composition and/or viscosity of the product over time, in particular through evaporation of its most volatile constituents.

in addition, it makes it possible to control the quantity of cosmetic product transferred to the applicator during each use, such that it makes an exact dosage possible of the product transferred to the applicator during each use, which makes it possible to avoid any wasting of the product, although with a traditional dispenser, the user cannot control the quantity present on the brush or on the applicator in general. In addition, this quantity risks changing according to whether the dispenser is full, half empty or almost empty.

furthermore, with the dispenser according to the invention, it is the body forming a reservoir that serves as a means of gripping, in such a way that the hand holds a handle of relative great length that ensures easy manipulation of the applicator.

finally, it is important to note that the dispenser according to the invention makes it possible to hold it with one hand, with said lower portion (6) held in the palm of the hand, and said upper portion (7) held between the thumb and the index finger, in such a way that it is easy to ensure a relative rotation of the upper portion in relation to the lower portion, and thereby transfer the cosmetic product to the applicator during make-up, without having to plunge the applicator back into the reservoir as with traditional dispensers.

List of marks

| | |
|---|---|
| Dispenser | 1 |
| Axial direction of 1 | 10 |
| Means of rotation of 7 in relation to 6 | 11 |
| Means of rotation through axial movement | 12 |
| Portion of helix | 120 |
| Radial projection | 121 |
| Rigid lug | 122 |
| Snap tongue | 123 |
| Axial groove | 124 |
| Radial stud | 125 |
| Means of rotation through relative rotation | 13 |
| Axial ribs | 130 |
| Axial grooves | 131 |
| Angular indicator - raised male portion | 132 |
| Angular indicator - hollow female portion | 133 |
| Means of reversible snapping of 2 and 5 | 14 |
| Axial body | 2 |
| Reservoir | 20 |
| First one-piece part | 21 |
| Moulded part of plastic material | 21′ |
| Second one-piece part | 22 |
| Moulded part of plastic material | 22′ |
| Means of cooperation in rotation of 60 and 40 | 23 |
| Means of cooperation in rotation of 7 and40 | 24 |
| Means of snapping of 6 and 7 | 25 |
| Application means | 3 |
| Applicator | 30 |
| Moulded part of plastic material | 30′ |
| Hollow axial rod | 31 |
| Channel of 31 | 310 |
| Central core of 30 | 32 |
| Hollow central core | 32′ |
| Central duct | 320 |
| Product distribution zone | 321 |
| Lateral opening | 322 |
| Application material of 30 | 33 |
| Means of transfer | 4 |
| Threaded piston | 40 |
| “Low” piston | 40a |
| “High” piston | 40b |
| Central threading of 40 | 400 |
| Peripheral threading of 40 | 401 |
| Central rod | 41 |
| Solid central rod | 41a |
| Hollow central rod | 41b |
| Threading | 410 |
| Axial duct of 41b | 411 |
| Upper end of 41b | 42 |
| Female tubular portion | 420 |
| Radial crown | 421, 421′ |
| Cap | 5 |
| Wiping means | 50 |
| Lower end of 5 | 51 |
| Exterior shell | 52 |
| Tubular insert | 53 |
| Mobile insert | 53a |
| Means of reversible snapping | 54 |
| Male rib or portion | 540 |
| Female groove or portion | 541 |
| Skirt of 5, of 52 | 55 |
| Wiper element | 56 |
| Wiping lip | 560 |
| Lower portion of 2 | 6 |
| Lower skirt | 60 |
| Bottom | 61 |
| Lower cavity | 62 |
| Upper opening | 63 |
| Tiered upper portion | 64 |
| First tier | 64a |
| Second tier | 64b |
| Shoulder | 640 |
| First shoulder | 640a |
| Second shoulder | 640b |
| Thinned axial portion | 641 |
| First thinned portion | 641a |
| Second thinned portion | 641b |
| Exterior gripping portion | 65 |
| Upper portion of 2 | 7 |
| Upper opening | 70 |
| Upper skirt | 71 |
| Transversal portion | 72 |
| Male tubular portion | 720 |
| Band | 8 |
| Cosmetic product | 9 |

1. Dispenser applicator of a cosmetic product having an axial direction and including:
a) an axial body including:
a1) a reservoir forming a cavity able to contain said cosmetic product,
a2) an application means of said cosmetic product,
a3) a means of transfer of said cosmetic product from said reservoir to said application means,
b) a cap cooperating with said body when said dispenser is closed, said cap including a wiping means of said application means, in such a way that said application means are wiped each time that said cap is separated from said body,
characterised in that:
1) said body includes a lower portion forming at least one portion of said reservoir, and an upper portion cooperating in rotation and delimiting said reservoir, said upper portion being solidly connected to said applications means and equipped with an upper opening making a passage of said product possible from said reservoir to said application means,
2) said means of transfer includes:
2a) a threaded piston mobile axially in said reservoir,
2b) a central rod solidly connected in rotation to said upper portion, said central rod extending axially in said reservoir, said piston cooperating with said central rod and with said lower portion in such a way that a relative rotation of said upper portion in relation to said lower portion forms a manual operation of said means of transfer by causing an axial movement of said piston and thereby a transfer of a fraction of said cosmetic product to said application means.

2. Dispenser according to claim 1 in which said application means includes an applicator and a hollow axial rod forming a channel emerging on said upper opening and in this way in communication with said reservoir, in such a way that said relative rotation causes a transfer of said product to said applicator.

3. Dispenser according to claim 1 wherein said applicator includes a central core and an application material, said central core being a hollow central core equipped with a central duct in communication with said channel of said hollow axial rod, said hollow central core including at least one lateral opening or one axial opening, in such a way that said relative rotation causes a direct transfer of said product onto said application material.

4. Dispenser according to claim 2 wherein said applicator forms a moulded part of plastic material.

5. Dispenser according to any of claim 1 wherein said lower portion includes one lower skirt and a bottom in such a way as to form a lower cavity of said reservoir, said lower skirt having an upper opening at its upper end, in such a way as to be able to fill said lower cavity with said product, said upper portion forming a means of sealing said upper opening.

6. Dispenser according to claim 1 wherein said upper portion includes a transversal portion including said upper opening and solidly connected to said hollow axial rod, said transversal portion cooperating in rotation with said central rod and forming said means of sealing said upper opening, said upper portion cooperating axially with said lower portion typically through axial cooperation of an upper skirt of said upper portion with said lower portion, or possibly using a band solidly connecting said upper portion axially to said lower portion.

7. Dispenser according to claim 5 wherein said lower skirt includes one upper portion tiered exteriorly including at least one tier equipped with a shoulder and a thinned axial portion, said tiered upper portion cooperating at least with said upper skirt of said upper portion.

8. Dispenser according to claim 7 in which said tiered upper portion includes two tiers, one said first tier with a said first shoulder corresponding typically to a reduction in exterior diameter from D₀ to D₁, and a said first thinned axial portion, and one said second tier with a said second shoulder corresponding typically to a reduction in exterior diameter of D₁ to D₂, and a said second thinned axial portion, said first tier being able to cooperate with a lower end of said cap of exterior diameter typically equal to D₀, and said second tier being able to cooperate with said upper skirt of said upper portion of exterior diameter typically equal to D₁.

9. Dispenser according to claim 1 wherein said upper and lower portions cooperate through axial snapping, typically irreversible, possibly thanks to a typically metal band forming a ring reinforcing the solidity of the cooperation between said upper and lower portions, while still making relative rotation possible of said upper and lower portions in relation to one another.

10. Dispenser according to claim 1 wherein said threaded piston k includes central threading cooperating with a corresponding threading of said central rod, said piston being solidly connected in rotation to said lower portion, typically through cooperation of axial ribs and grooves, or by an interior non-circular section of said lower skirt.

11. Dispenser according to claim 1 wherein said threaded piston includes a peripheral threading cooperating with a corresponding threading carried by an interior surface of said lower portion Ad, typically of said lower skirt, said piston being solidly connected in rotation with said central rod, typically thanks to a non-circular section.

12. Dispenser according to claim 2 wherein said central rod is a solid central rod, and wherein said piston is a low piston able to move axially to said upper portion during said relative rotation, so as to propel said product, via said upper opening to said application means or onto said application material.

13. Dispenser according to claim 2 wherein said central rod is a hollow central rod including an axial duct over typically all of its height, and wherein said piston is a high piston able to move away axially from said lower portion to said bottom during said relative rotation, in such a way as to ensure said direct transfer of said product onto said application material, said duct of said hollow central rod emerging on channel of the hollow axial rod of the application means.

14. Dispenser according to claim 13 in which said hollow central rod includes at its upper end, a female tubular portion cooperating typically with a male tubular portion of said transversal portion of said upper portion, said male tubular portion Em surrounding said upper opening, in such a way as to join together said hollow central rod to said male tubular portion, and thereby place into communication said hollow central rod and said hollow axial rod of said application means.

15. Dispenser according to claim 13 wherein said hollow central rod includes at its upper end at least one radial crown, said radial crown ensuring a tight closing of said reservoir and/or a centring of said hollow central rod.

16. Dispenser according to claim 1 wherein said axial body presents an axial height H₀ ranging typically from 60 mm to 160 mm, said application means presenting an axial height H₁ ranging from 20 mm to 60 mm, said upper portion presenting an axial height H₂ and said lower portion including an exterior gripping portion of axial height H₃, with H₀ equal to the sum of H₁+H₂+H₃, with H₂/H₃ ranging typically from 0.5 to 1.

17. Dispenser according to claim 2 wherein said upper portion and said hollow axial rod of said application means form a first one-piece part, typically a said first moulded part of plastic material.

18. Dispenser according to claim 1 wherein said upper portion and said application means form a second one-piece part, typically a said second moulded part of thermoplastic material.

19. Dispenser according to claim 1 wherein said upper and lower portions cooperate with a means of anti-rotation, in such a way as to make a single direction of relative rotation of said upper part possible in relation to said lower part, and ensure axial movement of said piston only in the direction corresponding to the transfer of said product from said reservoir to said application means, thereby preventing the entry of any air into said reservoir.

20. Dispenser according to claim 1 wherein said cap cooperates with said upper portion in such a way as to form a means of rotation of said upper portion in relation to said lower portion of a predetermined angle, a manual movement of said cap in relation to said lower portion thereby causing a relative rotation of said predetermined angle of said upper portion in relation to said lower portion.

21. Dispenser according to claim 20 in which said means of rotation is a means of rotation including a cooperation typically between a plurality of portions of helixes and at least one radial projection, said plurality of helixes and said radial projection being, for example, carried respectively on the exterior surface of said upper skirt and on the interior surface of an skirt of said cap, said manual movement being an axial movement over an axial distance d, typically less than 10 mm, said axial movement of said cap in relation to said lower part over said distance d causing a relative rotation of said upper portion in relation to said lower portion.

22. Dispenser according to claim 21 in which said radial projection includes a rigid lug and a snap tongue directed in such a way as to bend in contact with said portion of helix during the closing of said dispenser, and to not bend during the opening of said dispenser, in such a way that the axial movement of said cap in relation to said body causes the relative rotation of said upper portion in relation to said lower portion and thereby said transfer of a fraction of said cosmetic product to said application means.

23. Dispenser according to claim 20 wherein, so as to automatically direct said radial projection in relation to said plurality of portions of helix during the re-closing of said dispenser, a plurality of axial grooves and at least one radial stud cooperate, said plurality of axial grooves and said radial stud being, for example, carried respectively on the exterior surface of said lower skirt and on the interior surface of an skirt of said cap.

24. Dispenser according to claim 20 in which said means of rotation is a means of rotation including a cooperation typically between a plurality of axial ribs and grooves which cooperate when said dispenser is closed or almost closed, said manual movement being a relative rotation of said cap in relation to said lower portion, said cap and said upper portion including a means of causing rotation typically formed by said plurality of ribs, formed on the interior surface of said cap or on said upper skirt, cooperating with said plurality of axial grooves, formed respectively on said upper skirt or on the interior surface of said cap, in such a way that the manual rotation of said cap causes that of said upper portion.

25. Dispenser according to claim 24 in which said cap cooperates with said lower portion in such a way that said relative rotation has at least one given angular position whose crossing requires a manual effort that is greater than the standard effort of rotation, in such a way that, said relative rotation extending over a predetermined angular range corresponding to one dose of said product, any user can automatically and easily transfer said dose of product to said application means.

26. Dispenser according to claim 1 wherein said cap includes one exterior shell and one interior tubular insert including said wiping means, typically a circular wiping lip of a wiper element.

27. Dispenser according to claim 26 in which said insert is an axially mobile insert, able to slide in said shell until a bearing each time that said cap is separated from or assembled to said body, in such a way as to typically have a position referred to as “out” each time that said cap is separated from said body, said insert being therefore drawn by said application means to the exterior of said cap, taking into account the resistance offered by the wiping means during the passage of said application means, and a position referred to as “in” each time that said cap is assembled to said body, said wiping means of said insert being therefore drawn by said application means to the interior of said cap.

28. Dispenser according to claim 27 in which, in said “out” position, said insert cooperates with said exterior shell according to a means of reversible snapping, so as to make possible the at least partial introduction of said application means in said wiping means of said insert each time that said cap is assembled to said body, in such a way as to avoid any soiling of said shell by said product, said insert passing then from the “out” position to the “in” position at the bottom of the shell.

29. Dispenser according to claim 1 having an H/D form factor at least equal to 5, H being the height of said closed dispenser, and D corresponding to the greatest transversal dimension of said closed dispenser, typically at its diameter.
